(19) United States
(12) Patent Application Publication
(10) Pub. No.: US 2022/0397156 A1
(43) Pub. Date: Dec. 15, 2022

(54) BEARING INTEGRATED SEAL

(71) Applicant: MITSUBISHI CABLE INDUSTRIES, LTD., Tokyo (JP)

(72) Inventor: Nobukazu FUJII, Arida-shi (JP)

(73) Assignee: MITSUBISHI CABLE INDUSTRIES, LTD., Tokyo (JP)

(21) Appl. No.: 17/835,641

(22) Filed: Jun. 8, 2022

(30) Foreign Application Priority Data
Jun. 9, 2021 (JP) 2021-096501

(51) Int. Cl. F16C 33/78; F16J 15/3204

(52) U.S. Cl. CPC F16C 33/7876; F16J 15/3204

(57) ABSTRACT

A bearing integrated seal includes a cylindrical bearing member, an outer member covering at least an outer periphery and one axial direction end of the bearing member, an annular ring-shaped seal member provided such that one surface thereof covers the other axial direction end of the bearing member in an inner surface side of the outer member, and an inner member covering the other surface of the seal member in an opposite side to the one surface to fit the seal member to the bearing member in the inner surface side of the outer member, and the inner member is fixed to the outer member to fix the bearing member and the seal member.

### CROSS-REFERENCE TO RELATED APPLICATION

The present application is a continuation application filed under 35 U.S.C. 111(a) claiming benefit under 35 U.S.C. 120 and 365(c) of Japanese Patent Application No. 2021-096501 filed on Jun. 9, 2021, the entire contents of which are incorporated herein by reference.

### BACKGROUND OF THE INVENTION

### 1. Field of the Invention

The present disclosure relates to a bearing integrated seal used for a portion in which a bearing and a shaft seal of a vacuum pump, a compressor, an EGR valve, or the like, are proximately used.

### 2. Description of the Related Art

Conventionally, for example, as in Japanese Unexamined Patent Publication No. 2018-84292, a sintered bearing which is formed of a sintered material and includes a bearing sleeve having a shaft hole, an annular ring-shaped seal member provided such that one surface thereof is in contact with the bearing sleeve, and a washer member provided in contact with the other surface of the seal member in an opposite side to the surface thereof to fit the seal member to the bearing sleeve, and in which the washer member is fixed to the bearing sleeve has been known. In this type of sintered bearing, the seal member is integrally formed, and therefore, space saving, reduction in costs, or the like can be advantageously achieved.

### SUMMARY OF THE INVENTION

However, in the sintered bearing described in Japanese Unexamined Patent Publication No. 2018-84292, in a case where a bearing portion is exposed to sealed fluid, a problem in corrosion resistance arises.

In a case where the seal member is caulked and joined directly to the bearing member, depending on a material of the bearing member, a problem arises in which integration is difficult due to insufficiency of rigidity of the bearing member itself

In view of the foregoing, the present disclosure has been devised and it is therefore an object of the present disclosure to achieve a bearing integrated seal having excellent rigidity and corrosion resistance.

In order to achieve the above-described object, according to the present disclosure, a bearing member and a seal member are covered by an outer member and inner member.

Specifically, according to the present disclosure, a bearing integrated seal includes a cylindrical bearing member, an outer member covering at least an outer periphery and one axial direction end of the bearing member, an annular ring-shaped seal member provided such that one surface thereof covers the other axial direction end of the bearing member in an inner surface side of the outer member, and an inner member covering the other surface of the seal member in an opposite side to the one surface to fit the seal member to the bearing member in the inner surface side of the outer member, and the inner member is fixed to the outer member to fix the bearing member and the seal member.

### BRIEF DESCRIPTION OF THE DRAWINGS

FIG. 1 is a cross-sectional view illustrating a bearing integrated seal according to an embodiment of the present disclosure.

FIG. 2 is a perspective view of the bearing integrated seal with a portion broken.

FIG. 3 is a perspective view of a bearing integrated seal according to a modified example of the embodiment according to the present disclosure, corresponding to FIG. 2.

### DETAILED DESCRIPTION

According to a first aspect of the present disclosure, a bearing integrated seal includes a cylindrical bearing member, an outer member covering at least an outer periphery and one axial direction end of the bearing member, an annular ring-shaped seal member provided such that one surface thereof covers the other axial direction end of the bearing member in an inner surface side of the outer member, and an inner member covering the other surface of the seal member in an opposite side to the one surface to fit the seal member to the bearing member in the inner surface side of the outer member, and the inner member is fixed to the outer member to fix the bearing member and the seal member.

According to the above-described structure, the inner member is fixed to the outer member, and thus, the bearing member and the seal member can be fixed so as to be sandwiched between the inner member and the outer member in an axial direction. Therefore, even in a case where the bearing member is formed of a sintered member having relatively low rigidity, sufficient rigidity can be ensured. Moreover, the bearing member is sandwiched between the outer member and the seal member, and therefore, the bearing member is not exposed to sealed fluid and thus has excellent corrosion resistance. Furthermore, the seal member is integrally formed with the bearing member, and therefore, the number of parts is reduced, thereby facilitating mounting and saving a space.

According to a second aspect of the present disclosure, in the first aspect, the inner member has an L shape in a cross section, an axial direction flat surface of the inner member covers the other surface of the seal member, and an outer peripheral flat surface of the inner member is in contact with an inner peripheral flat surface of the outer member.

According to the above-described structure, the inner member is face contacted with the outer member and is reliably fixed to the outer member.

According to a third aspect of the present disclosure, in the second aspect, an end portion of the inner member in an opposite side to the axial direction flat surface is caulked and joined with an end portion of the outer member in an opposite side to the bearing member.

According to the above-described structure, caulking joining is provided in a state where the inner member is face contacted with the outer member, and therefore, the bearing member and the seal member are reliably fixed.

According to a fourth aspect of the present disclosure, in any one of the first to third aspects, the inner member covers the other surface of the seal member with an annular ring-shaped gasket interposed therebetween. According to the above-described structure, a leak (internal leak) flowing between the inner member and the seal member can be prevented.

According to a fifth aspect of the present disclosure, in any one of the first to fourth aspects, the outer member covers the one axial direction end of the bearing member with an annular ring-shaped gasket interposed therebetween.

According to the above-described structure, a leak (internal leak) flowing between the outer member and the bearing member can be prevented.

According to a sixth aspect of the present disclosure, in any one of the first to fifth aspects, the seal member covers the other axial direction end of the bearing member with an annular ring-shaped gasket interposed therebetween.

According to the above-described structure, a leak (internal leak) flowing between the seal member and the bearing member can be prevented.

As has been described above, according to the present disclosure, a bearing integrated seal having excellent rigidity and corrosion resistance can be achieved.

An embodiment of the present disclosure will be described below with reference to the accompanying drawings.

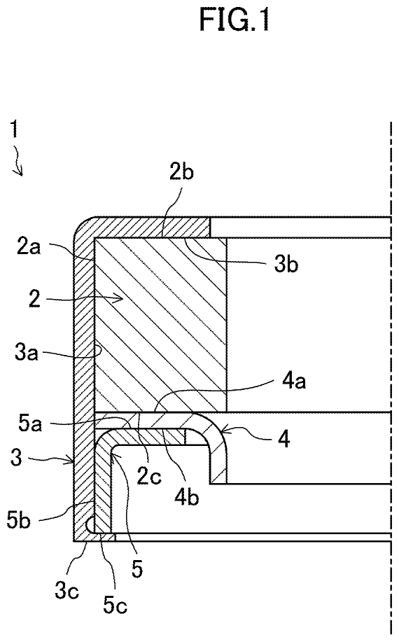

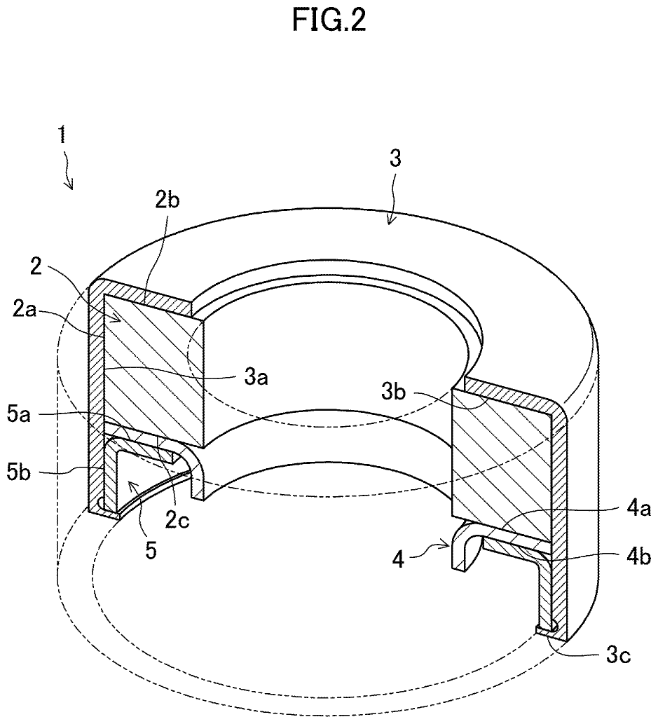

FIG. 1 and FIG. 2 illustrate a bearing integrated seal 1 of an embodiment of the present disclosure, and the bearing integrated seal 1 includes a cylindrical bearing member 2. The bearing member 2 may be formed of various materials. For example, the bearing member 2 may be formed of a sintered material, and may be a bush formed of a copper alloy, carbon, resin, or the like.

The bearing integrated seal 1 includes an outer member 3 covering at least an outer periphery 2a and one axial direction end 2b of the bearing member 2. A one axial direction flat surface 3b of the outer member 3 is face contacted with the one axial direction end 2b of the bearing member 2. It is preferable that the outer member 3 has, for example, an annular ring shape formed such that a portion is bent and is a metal member formed of a stainless steel sheet, a cold-rolled steel sheet, or the like. In the outer member 3, a material, such as a stainless steel sheet or the like, having high corrosion resistance is suitable for a portion that requires corrosion resistance but, depending on a case, some other material than a metal material may be used, as long as the material is a rigid body that can be bent.

The bearing integrated seal 1 includes an annular ring-shaped seal member 4 provided such that one surface 4a thereof covers the other axial direction end 2c of the bearing member 2 in an inner surface side of the outer member 3. The seal member 4 is formed of a resin material, such as nylon, polyethylene, polytetrafluoroethylene (PTFE) that is chemically stable and has excellent heat resistance and chemical resistance, or the like, a rubber material, or the like.

The bearing integrated seal 1 further includes an inner member 5 covering the other surface 4b of the seal member 4 in an opposite side to the one surface 4a and fitting the seal member 4 to the bearing member 2 in the inner surface side of the outer member 3. The inner member 5 is fixed to the outer member 3 to fix the bearing member 2 and the seal member 4.

The inner member 5 has, for example, an annular ring shape and a L shape in a cross section formed by bending, an axial direction flat surface 5a of the inner member 5 covers the other surface 4b of the seal member 4, and an outer peripheral flat surface 5b of the inner member 5 is in contact with an inner peripheral flat surface 3a of the outer member 3. The inner member 5 is also preferably a metal member, such as a stainless steel sheet, a cold-rolled steel sheet, or the like, but, depending on a case, may be a rigid body that can be bent. For a portion that requires corrosion resistance, a material, such as a stainless steel sheet or the like, having high corrosion resistance is suitable.

An end portion 5c of the inner member 5 in an opposite side to the axial direction flat surface 5a is caulked and joined with an opposite-side end portion 3c of the outer member 3 in an opposite side to the bearing member 2. For example, the opposite-side end portion 3c can be easily caulked and joined when the opposite-side end portion 3c is formed to be thinner than the other portions. Caulking joining is provided by the opposite-side end portion 3c in a state where the outer peripheral flat surface 5b of the inner member 5 is face contacted with the inner peripheral flat surface 3a of the outer member 3, and therefore, the bearing member 2 and the seal member 4 are reliably fixed.

As has been described above, the inner member 5 is reliably fixed to the outer member 3, and thus, the bearing member 2 and the seal member 4 can be fixed so as to be sandwiched between the inner member 5 and the outer member 3 in an axial direction. Therefore, even in a case where the bearing member 2 is formed of a sintered member having relatively low rigidity, sufficient rigidity can be ensured.

Moreover, the bearing member 2 is sandwiched between the outer member 3 and the seal member 4, and therefore, the bearing member 2 is not exposed to sealed fluid and has excellent corrosion resistance.

Furthermore, the seal member 4 is integrally formed with the bearing member 2, and therefore, the number of parts is reduced, thereby facilitating mounting and saving a space.

Therefore, according to the bearing integrated seal 1 according to this embodiment, the bearing integrated seal 1 having excellent rigidity and corrosion resistance can be achieved.

### Modified Example

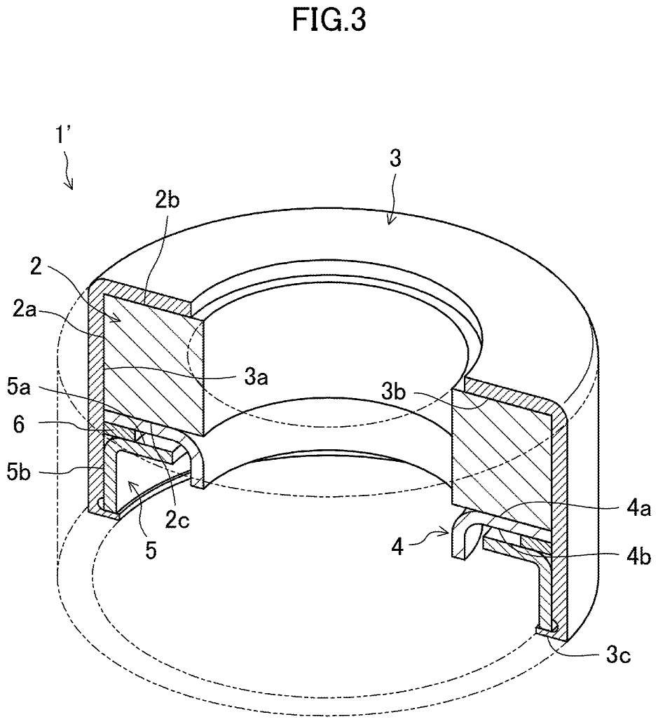

FIG. 3 illustrates a bearing integrated seal 1′ according to a modified example of the above-described embodiment of the present disclosure and the modified example is different from the above-described embodiment in a point that a gasket 6 is provided. In this modified example, each component common in FIG. 1 and FIG. 2 is identified by the same reference character, and the detailed description thereof will be omitted.

The inner member 5 covers the other surface 4b of the seal member 4 with an annular ring-shaped gasket 6 interposed therebetween. That is, the gasket 6 is sandwiched between the axial direction flat surface 5a of the inner member 5 and the other axial direction end 2c of the bearing member 2. With the gasket 6 provided, a leak (internal leak) flowing between the axial direction flat surface 5a of the inner member 5 and the other surface 4b of the seal member 4 can be prevented.

A position of the gasket 6 is not limited to a position described in this modified example. Although not illustrated, for example, the outer member 3 may be configured to cover the one axial direction end 2b of the bearing member 2 with the annular ring-shaped gasket 6 interposed therebetween. In this case, with the gasket 6 provided, a leak (internal leak) flowing between the one axial direction flat surface 3b of the outer member 3 and the one axial direction end 2b of the bearing member 2 can be prevented.

Moreover, the seal member 4 may be configured to cover the other axial direction end 2c of the bearing member 2 with the annular ring-shaped gasket 6 interposed therebetween. In this case, with the gasket 6 provided, a leak (internal leak) flowing between the one surface 4a of the seal member 4 and the other axial direction end 2c of the bearing member 2 can be prevented.

A plurality of gaskets 6 may be provided in the above-described plurality of positions.

Note that the above-described embodiment is merely a preferable example by nature and is not intended to be particularly limiting the present disclosure, application of the present disclosure, and the scope of use.

What is claimed is:

1. A bearing integrated seal comprising:
a cylindrical bearing member;
an outer member covering at least an outer periphery and one axial direction end of the bearing member;
an annular ring-shaped seal member provided such that one surface thereof covers the other axial direction end of the bearing member in an inner surface side of the outer member; and
an inner member covering the other surface of the seal member in an opposite side to the one surface to fit the seal member to the bearing member in the inner surface side of the outer member, wherein
the inner member is fixed to the outer member to fix the bearing member and the seal member.

2. The bearing integrated seal of claim 1, wherein
the inner member has an L shape in a cross section, an axial direction flat surface of the inner member covers the other surface of the seal member, and an outer peripheral flat surface of the inner member is in contact with an inner peripheral flat surface of the outer member.

3. The bearing integrated seal of claim 2, wherein
an end portion of the inner member in an opposite side to the axial direction flat surface is caulked and joined with an end portion of the outer member in an opposite side to the bearing member.

4. The bearing integrated seal of claim 1, wherein
the inner member covers the other surface of the seal member with an annular ring-shaped gasket interposed therebetween.

5. The bearing integrated seal of claim 1, wherein
the outer member covers the one axial direction end of the bearing member with an annular ring-shaped gasket interposed therebetween.

6. The bearing integrated seal of claim 1, wherein
the seal member covers the other axial direction end of the bearing member with an annular ring-shaped gasket interposed therebetween.
